(19) United States
(12) Patent Application Publication
(10) Pub. No.: US 2023/0274646 A1
(43) Pub. Date: Aug. 31, 2023

(54) METHOD FOR EFFICIENT ROUTE PLANNING OF VEHICLES IN A SORTING SYSTEM

(71) Applicant: Fraunhofer-Gesellschaft zur Foerderung der angewandten Forschung e.V., Munich (DE)

(72) Inventors: Moritz ROIDL, Dortmund (DE); Jan Sören EMMERICH, Dortmund (DE); Leonie BENKENSTEIN, Dortmund (DE); Patrick KLOKOWSKI, Dortmund (DE); Christian HAMMERMEISTER, Dortmund (DE)

(21) Appl. No.: 18/312,506

(22) Filed: May 4, 2023

Related U.S. Application Data
(63) Continuation of application No. PCT/EP2021/080790, filed on Nov. 5, 2021.

(30) Foreign Application Priority Data
Nov. 8, 2020 (DE) 102020214005.7

(51) Int. Cl. G08G 1/16; B60W 30/095; B60W 40/10

(52) U.S. Cl. CPC G08G 1/164; B60W 30/095; B60W 40/10; G05D 2201/0216; B60W 2720/00

(57) ABSTRACT

A sorting system includes a plurality of vehicles configured to move along trajectories in the sorting system. The sorting system includes a calculator configured to calculate a third number of trajectories between a first number of start points and a second number of end points, wherein a speed specification for a vehicle along the trajectories is allocated to each trajectory. The sorting system includes a coordinator configured to transmit drive requests to the plurality of vehicles, wherein each drive request includes a drive from one of the start points to one of the end points along one of the trajectories. Further, the sorting system includes a collision avoidance unit to amend the speed specification allocated to the trajectory based on the collision information to obtain an amended speed specification and to prevent the possible collision.

### CROSS-REFERENCE TO RELATED APPLICATIONS

This application is a continuation of copending International Application No. PCT/EP2021/080790, filed Nov. 5, 2021, which is incorporated herein by reference in its entirety, and additionally claims priority from German Application No. 102020214005.7, filed Nov. 8, 2020, which is also incorporated herein by reference in its entirety.

The present invention relates to a sorting system, to sorting system control means and to methods of operating the same. In particular, the present invention relates to a method for efficient route planning of vehicles in the sorting system.

### BACKGROUND

In sorting systems based on vehicles, the transport performance has to be provided by a large number of vehicles traveling in a confined space at high speed and acceleration to provide sufficient overall system performance. Each individual vehicle picks up transport goods at a source while driving slowly, the same drives along a pre-calculated trajectory with high acceleration and braking behavior close to the maximum speed to the sink, and there the same dispatches the goods while driving slowly.

Several different types of obstructions can occur in a sorting system, especially in multi-robot systems illustrated in FIGS. 4a to 4f.

FIG. 4a shows an exemplary scenario in which two vehicles 120₁ and 120₂ move towards each other along a trajectory 140, for example along opposite directions of travel, which can lead to a so-called head-to-head collision.

FIG. 4b shows a scenario in which the vehicles 120₁ and 120₂ are traveling along the same direction on the same trajectory 140, but a vehicle 120₁ driving behind the vehicle 120₂ is driving at a speed V₁ that is greater than the speed V₂, so that a head-to-tail collision can occur when the vehicle 120₂ catches up. Therefore, FIGS. 4a and 4b show possible scenarios for collisions.

FIG. 4c shows a scenario in which vehicles 120₁ and 120₂ and 120₃ and 120₄, respectively, are traveling on different trajectories 140₁ and 140₂, but the trajectories connect with each other at a meeting point 160 to form one trajectory 140g, so that a congestion can occur during sorting, for example, because the meeting point 160 can only be traveled by one vehicle at a time, but a higher number arrive from the trajectories 140₁ and 140₂. This can result in formation of queues.

FIG. 4d shows a scenario in which vehicles 120₁ and 120₂ on the trajectory 140₁ are to sort themselves onto trajectory 140₂ on which vehicles 120₃ to 120₆ are already traveling, so that there is insufficient space for sorting. Based on right-of-way rules, vehicles on the trajectory 14₁ can have to wait until a vehicle flow from the trajectory 140₂ has sufficient distance before the meeting point 160 or comes to a standstill. FIG. 4b thus shows a partial or local vehicle standstill, a so-called livelock.

FIGS. 4e and 4f, on the other hand, show a non-local deadlock in FIG. 4e and a local deadlock in FIG. 4f.

Each of these scenarios involves solution of the problem or avoidance of the scenario to maintain smooth operations.

In classic sorting systems with conveyor belt or tilting trays, the goods are transported at high speed on the conveyor belt or the tilting trays, respectively. Falling down in curves is prevented by appropriate guard rails. At technically complex supply inputs, the transported goods are accelerated to the main speed of the sorting circuit and brought to a free position or tray. Discharging takes place at the sink by simply brushing off or tilting the tray. Due to the fixed circuit and the targeted input and output, there are no obstructions between the transported goods.

Existing sorting systems with autonomous vehicles and free movability operate at low speeds of, for example, a maximum of three meters per second and with large safety distances. Alternatively, vehicles drive on fixed routes with block-based reservations or on a checkerboard-like grid, which greatly simplifies the algorithmic complexity of coordinating many vehicles. Here, almost all of the existing algorithms are based on modifications of the A* algorithm that allow simultaneous optimization of the paths for several vehicles. This problem is also referred to as “multi-agent pathfinding”, i.e. pathfinding for several participants.

This, there is a need for flexible sorting systems where goods can be transported at high speeds.

### SUMMARY

According to an embodiment, a sorting system control means may have: coordinating means configured to transmit drive requests to a plurality of vehicles, wherein each drive request includes a drive from a start point to an end point along a respective trajectory; wherein a speed specification for a vehicle along the trajectory is allocated to each trajectory; collision avoidance means configured to examine, for a new drive request, an allocated trajectory for possible collisions with a drive request to obtain collision information indicating a possible collision; and to amend the speed specification allocated to the trajectory based on collision information to obtain an amended speed specification; and to prevent the possible collision; an interface for outputting the new drive request including an instruction that includes the trajectory and the amended speed specification.

According to another embodiment, a sorting system may have: a plurality of vehicles configured to move along trajectories in the sorting system; sorting system control means according to any of the preceding claims including calculating means configured to calculate a third number of trajectories between a first number of start points and a second number of end points, wherein a speed specification for a vehicle along the trajectory is allocated to each trajectory; wherein the sorting system is configured to transmit, by means of the interface, the new drive request including the instruction that includes the trajectory and the amended speed specification to a control of a vehicle.

According to another embodiment, a method for operating a sorting system control means may have the steps of: transmitting drive requests to a plurality of vehicles, such that each drive request includes a drive from a start point to an end point along a respective trajectory; such that a speed specification for a vehicle along the trajectory is allocated to each trajectory; examining, for a new drive request, an allocated trajectory for possible collisions with a drive request to obtain collision information indicating a possible collision; and amending the speed specification allocated to the trajectory based on the collision information to obtain an amended speed specification ; and to prevent the possible collision; outputting the new drive request including an instruction that includes the trajectory and the amended speed specification.

A core idea of the present invention is the finding that a pre-determination of trajectories between start points and end points with a respective associated speed profile or speed specification can be subsequently amended as needed to avoid possible collisions between several trajectories in order to adjust the drive request. This makes it possible to use the different trajectories to obtain high flexibility in the sorting system and further to implement high speeds, since the calculation effort for adapting the drive requests is low and can be limited, for example, to vehicles that are not yet driving, so that the vehicles that are driving can drive at high speed.

According to an embodiment, a sorting system comprises a plurality of vehicles configured to move along trajectories in the sorting system. The sorting system comprises calculating means configured to determine a third number of trajectories between a first number of start points and a second number of end points, each trajectory being associated with a speed specification for a vehicle along the trajectory. The sorting system includes coordinating means configured to transmit drive requests to the plurality of vehicles, each drive request including a drive from one of the start points to one of the end points along one of the trajectories. The sorting system includes collision avoidance means configured to, for a new drive request, examine a trajectory for possible collisions with another vehicle of the sorting system to obtain collision information indicating a possible collision, such that the collision avoidance means changes the speed specification associated with the trajectory based on the collision information to obtain an amended speed specification, and to avoid the possible collision. The sorting system is configured to transmit the new drive request including an instruction that includes the trajectory and the amended speed specification to the vehicle or the vehicle control.

According to an embodiment, the calculating means is configured to determine a plurality of trajectory candidates between a start point of the first number of start points and an end point of the second number of end points, and the coordinating means is configured to select one of the trajectory candidates as a trajectory for the new drive request. This allows for a high degree of flexibility since several possible paths are considered.

According to an embodiment, the calculating means is configured to determine the plurality of trajectory candidates considering a trajectory curvature. The calculating means is configured to determine a predefined number of trajectory candidates of minimum curvature and/or a number of trajectory candidates having trajectory curvatures of at most a predefined curvature threshold. This makes it possible to keep the calculating effort within predetermined limits.

According to an embodiment, the calculating means is configured to calculate the trajectory based on splines. This enables a high efficiency of the calculation.

According to an embodiment, the calculating means is configured to determine a distance for control points between the start point and the end point of the trajectory, which indicates a distance of neighboring trajectory candidates. In this way, a calculation of trajectories that cannot be realized later can be avoided or additional safety aspects can be taken into account.

According to an embodiment, the calculating means is configured to calculate the speed specification kinodynamically as a time-optimized speed specification. On the one hand, this makes it possible to exploit high to maximum speeds of the vehicle and, at the same time, to limit the speed specification adjustment to a reduction of the high speed because it enables a low calculation effort.

According to an embodiment, the trajectory is configured to include a number of trajectory portions. The calculating means is configured to calculate a portion speed specification for each trajectory portion, and to calculate the speed specification based on a combination of the portion speed specifications. This enables a time-varying speed profile.

According to an embodiment, the calculating means is configured to calculate, for each trajectory portion based on a curvature of the trajectory portion and based on a maximum acceleration of a vehicle, a maximum speed possibly associated with the respective vehicle type. Based on the maximum speed, a speed specification at the beginning of the trajectory portion, and a speed specification at an end of the trajectory portion, the portion speed specification can be calculated by the calculating means. This allows a good utilization of possible maximum accelerations to obtain the highest possible, even maximum speed on the portion.

According to an embodiment, the coordinating means is configured to select the trajectory for the new drive request from a plurality of trajectory candidates. The plurality of trajectory candidates takes into account trajectories already assigned to vehicles in existing drive requests. This enables efficient avoidance of blockages by avoiding overload of trajectories, taking into account, for example, vehicles that are already driving or will soon be starting.

According to an embodiment, the collision avoidance means is configured not to adapt the speed specification for already assigned trajectories of existing drive requests. This allows a significant reduction of possible calculations so that results can be obtained quickly.

According to an embodiment, the coordinating means is configured to consider vehicles on already assigned trajectories as potential obstacles for the selection of the trajectory. This enables a reduction of the selection space for possible further decisions and thus low calculating efforts.

According to an embodiment, the collision avoidance means is configured to obtain a plurality of corresponding trajectories for a plurality of new drive requests as a respective time-optimal speed specification for traversing the trajectory, and to determine possible collisions between the vehicles for the plurality of new trajectories, and to avoid the possible collisions within the new drive requests by adapting at least one of the speed specifications. This allows new drive requests to be coordinated with each other so that the same can take each other into account.

According to an embodiment, time-optimized collision-free drive requests are obtained globally for the plurality of vehicles by means of amended speed specifications. This optimizes not only individual vehicles, but also the overall throughput of the sorting system.

According to an embodiment, the collision avoidance means is configured to determine for which of the vehicles involved in the possible collision the speed specification is to be adapted. A corresponding assessment makes it possible to maintain the overall throughput of the sorting system high, even if individual vehicles are slowed down more as a result.

According to an embodiment, the collision avoidance means is configured to use at least one of a predefined priority, an exhaustive search method, and a combination thereof to determine for which of the vehicles involved in the potential collision the speed specification is to be adapted. This enables optimization of the overall throughput based on appropriate criteria, such as since there can be transport requests that are advantageous even if the overall throughput is desired to be high.

According to an embodiment, the collision avoidance means is configured to determine possible collisions for a plurality of new drive requests and to match the speed specifications to the speed profiles assigned to the drive requests by the coordinating means. Speed profiles that have already been transmitted remain unamended. This enables new drives to be adapted to existing or matched drives.

According to an embodiment, the collision avoidance means is configured to treat already amended speed specifications that have already been determined on vehicles as unchangeable until the drive request on the assigned trajectory is completed.

According to an embodiment, the start point and/or an end point is a stationary area in the sorting system. Alternatively or additionally, one of the start points and/or one of the end points can be based on the trajectory and thus be variable across different trajectories. This allows for a high degree of planning flexibility.

According to an embodiment, the plurality of vehicles are holonomic vehicles or at least include such vehicles. Holonomic vehicles are particularly suitable for the flexible trajectories and high speeds possible with the described embodiments.

According to an embodiment, the coordinating means is configured to transmit the new drive request as a joint drive request to a vehicle group or a vehicle formation for a common drive of several vehicles along the trajectory. This also enables the transport of large and/or heavy objects.

Another embodiment of the present invention provides sorting system control means. The same comprises, for example, the coordinating means and the collision avoidance means described herein, and an interface for outputting the new drive request.

Further embodiments relate to methods for operating a sorting system or sorting system control means.

### BRIEF DESCRIPTION OF THE DRAWINGS

Embodiments of the present invention will be detailed subsequently referring to the appended drawings, in which:

FIG. 1 is a schematic block diagram of a sorting system according to an embodiment;

FIG. 2 is a schematic illustration of a part of a sorting system according to an embodiment, in which exemplary areas are illustrated that can be used as start point and/or end point for a trajectory;

FIG. 3a-c are schematic graphs explaining a determination of a speed specification for a trajectory according to an embodiment; and

FIG. 4a-f are schematic illustrations of known obstructions in a sorting system.

### DETAILED DESCRIPTION

Before embodiments of the present invention are explained in detail in the following with reference to the drawings, it is pointed out that identical, functionally equal or equal elements, objects and/or structures are provided with the same reference numbers in the different figures, so that the description of these elements illustrated in different embodiments is interchangeable or interapplicable.

Embodiments described below are described in the context of a plurality of details. However, embodiments can be implemented without these detailed features. Further, for the sake of clarity, embodiments are described using block diagrams as a substitute for a detailed representation. Furthermore, details and/or features of individual embodiments can be combined with each other, as long as it is not explicitly described to the contrary.

Embodiments described herein relate to the movement of vehicles along trajectories. In some of the embodiments described herein, such a trajectory is described from a start point to an end point such that, for example, transport goods can be picked up at the start point and dispatched at an end point. However, the embodiments described herein are not limited thereto. Rather, a start point or end point can also be a differently configured point or area in the sorting system, for example a path at which change is made into another spatial area of the sorting system, for example an exit or entrance of a transport goods hall or warehouse. Also, the start points or end points or start areas or end areas can also be considered dynamically and be, for example, a start or an end of a partial trajectory on a path from a transport material pick-up point to a transport material dispatch point, so that such start points or end points can also be distributed arbitrarily in space and along trajectories.

Embodiments as well as the inventive core idea are based on considerations of using kinodynamic path planning in vehicle-based sorting systems. That is, in some of the embodiments described herein for calculating trajectories and speeds, kinodynamic path planning is used. Compared to classical methods, kinodynamic path planning not only determines a collision-free path through an environment with obstacles, which implies a kinematic boundary conditions, but also takes into account along this path the physically maximum possible speeds and accelerations, i.e. dynamic boundary conditions. In particular, this is intended to solve the object for which combination of speed and trajectory in the minimum possible travel time results at which the vehicle just does not break free in an uncontrolled manner. Kinodynamic path planning includes a planning component, predictive path planning, which can be done offline, and a reactive component, which can be done online during operation to allow control of the stability of the vehicle motion during execution. In sum, the same places high demands on the performance of the algorithms and on-board computers used, because the determined route has to be collision-free and the vehicle's trajectory along the route has to satisfy the dynamic boundary conditions. In addition, the determined route should be optimal, for example, have a shortest route to the destination. One requirement is to provide such calculations reliably and in real time.

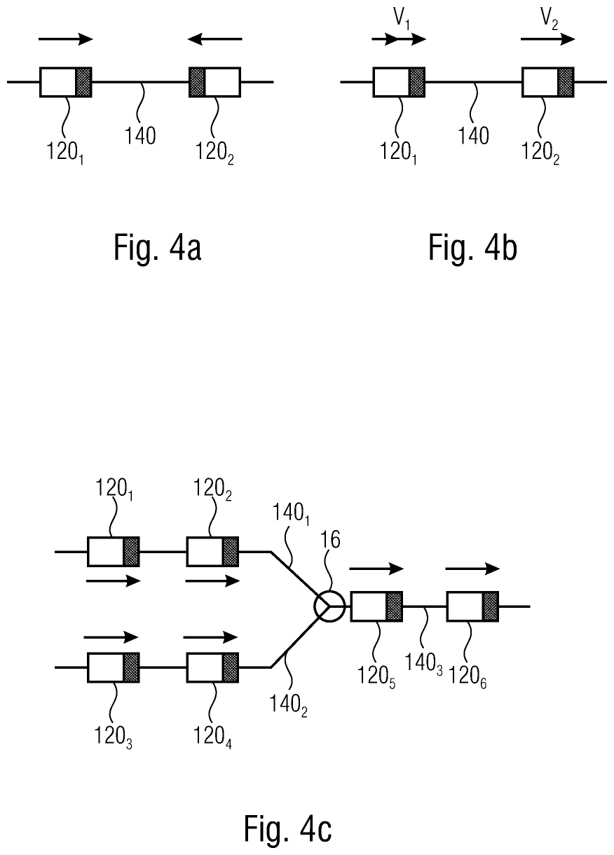

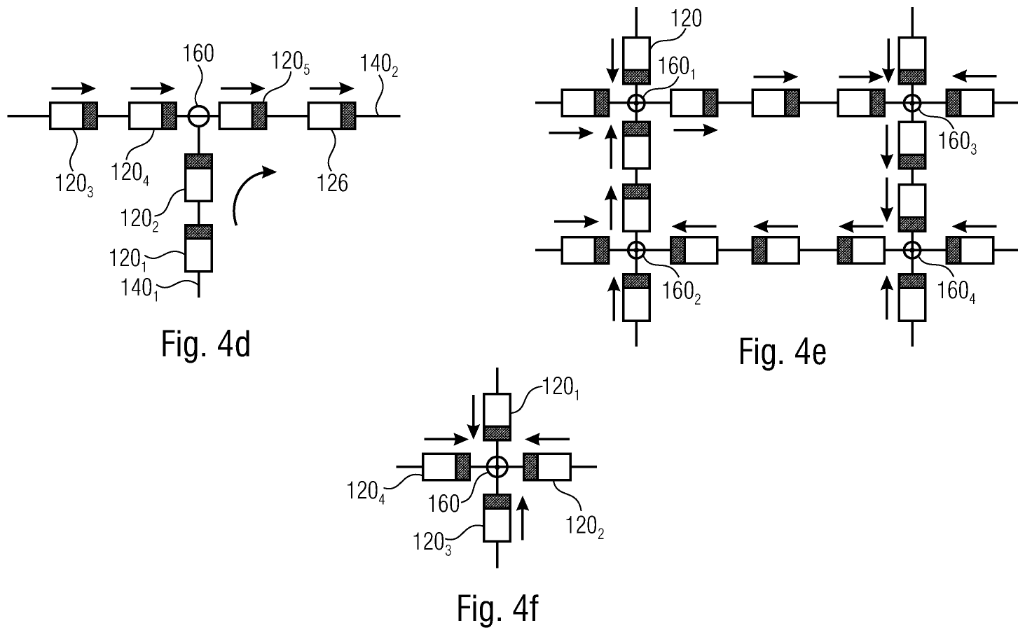

Embodiments are aimed at solving the technical problem of coordinating many vehicles with their complex kinodynamic path planning, i.e. trajectories and speed profiles, in such a way that no obstructions occur between the vehicles, as described in connection with FIGS. 4a to 4f, and at the same time the needed logistical performance in transported packages per hour is achieved. An additional challenge in this respect is posed by groups of several vehicles driving in formation, for example, in order to carry out a larger transport request or a bulky goods transport together.

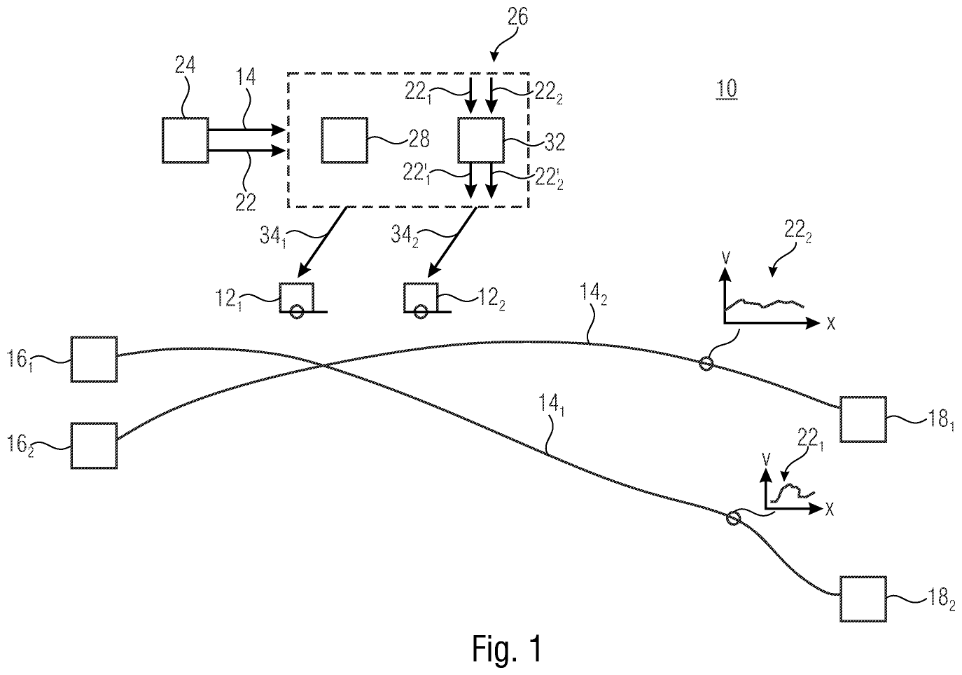

FIG. 1 shows a schematic block diagram of a sorting system 10 according to an embodiment. The sorting system 10 comprises a plurality of vehicles 12₁ and 12₂ configured to move within the sorting system 10 along trajectories 14₁ and 14₂. A number of vehicles 12₁ and 12₂ is arbitrary and can be two or more, five or more, ten or more, twenty or more, or even a hundred or more. A number of trajectories 14 is independent of this, even though only two trajectories 14₁ and 14₂ are illustrated in FIG. 1. These are exemplarily selected so that the trajectory 14₁ connects a start point 16₁ and an end point 18₂ and describes a route between the points 16₁ and 18₂. Similarly, the trajectory 14₂ describes a path or route between a start point 16₂ and an end point 18₁. The start points and end points can be arranged next to each other or distributed from each other in the sorting system as desired. Other possible trajectories include, for example, a connection between the start point 16₂ and the end point 18₂ and/or between the start point 16₁ and the end point 18₁. Nevertheless, it is not necessary that a trajectory be provided in the sorting system 10 between each start point and each end point, nor is it necessary that only one trajectory be possible between a specific pair of start points to an end point; rather, a plurality or multitude of trajectory candidates can be possible, as will be discussed in detail later.

Each trajectory 14₁ and 14₂ can be assigned a speed specification 22₁ and 22₂, respectively, which can also be referred to as a speed profile. The speed specification 22₁ and/or 22₂ can have a specification for a speed v, which can be constant but also variable across a path x of the trajectory 14₁ and 14₂, respectively. The speed specification 22₁ and 22₂ can include an instruction to the vehicle regarding a speed to be adjusted or achieved or driven along the trajectory or a part thereof.

The sorting system 10 includes calculating means 24 that is configured to calculate a number of trajectories 14 between the start points 16 and the end points 18. Each of the trajectories is thereby assigned a speed specification 22 for a vehicle 12 of the sorting system along the trajectory 14. Here it is possible that for the use of different vehicles, for example different with regard to speeds, transport volume, transport weight, energy consumption or the like, different vehicles are used in the sorting system 10, so that for the same path different speed specifications can exist in dependence on different vehicles, in particular with regard to the optional design as kinodynamic path planning.

The sorting system 10 further comprises sorting system control means 26, which can comprise coordinating means 28 and collision avoidance means 32. The coordinating means 28 and the collision avoidance means 32 can also be implemented independently of the sorting system control means 26, for example as individual components and/or as components of vehicles. Alternatively or additionally, the calculating means 24 can also be part of the sorting system control means, although this is not intended to exclude embodiments in which the information about the trajectories and/or speed specifications is obtained from a possibly remotely located computing system, for which purpose computing units of a possibly remotely located service provider can be considered as well as distributed computing services, for example so-called cloud services. Even if a calculation of the trajectory is performed in parts on external computing units, embodiments refer regardless to sorting systems with calculating means that adapts the corresponding calculation results to the existing sorting system.

The coordinating means 28 is configured to transmit drive requests 34₁ and 34₂ to the vehicles 12₁ and 12₂. Each of the drive requests 34₁ and 34₂ describes, defines, or includes a drive from one of the start points 16ᵢ to one of the end points 18ⱼ along one of the trajectories 14k. As part of the drive requests 34, which can also be referred to as transport requests, speed specifications 22₁ and 22₂ can also be transmitted to the vehicles. Alternatively, information adapted to identify information pre-stored in the vehicles can also be transmitted to the vehicles, such that the route and/or speed profile is already pre-stored on the vehicles and selected using, for example, an indicator, identifier or other designator using the drive requests 34 in the vehicles. Alternatively or additionally, the vehicles can also comprise advance information about available routes, so that the drive request 34 can be understood as a selection of a possible drive or a trajectory from those known in advance. A speed specification for the drive can be stored in advance in a memory of the vehicle, for example in the same memory in which the possible drives are also stored. Alternatively, the drive request, i.e. the trajectory and/or the speed specification, can be transmitted to the vehicle, for example using radio technologies.

The collision avoidance means 32 can be implemented at least in part as part of a sorting system control and/or at least in part in one or more vehicles, such as comprising a processor, a microcontroller, a field programmable gate array (FPGA), or the like. When implemented at least in part in a vehicle, each of the respective vehicles can be configured, for example, to avoid a collision for its own drive request and, if needed, to perform corresponding examinations and/or provide instructions for other vehicles.

The collision avoidance means 32 is configured to examine a trajectory of a new drive request, i.e. a drive request to be added, for possible collisions with another vehicle of the sorting system. The further vehicle can be a vehicle for which a drive request or drive planning is also being carried out, or it can be a vehicle that is already driving. For example, the vehicle 12₁ can already have completed planning of its trajectory and the drive request 34₂ can be considered a new drive request in this scenario. The collision avoidance means is configured to obtain collision information indicating a possible collision of the drive request 34₂ with the drive request 34₁, a collision for this purpose being understood as any possible type of mutual blocking, examples of which are shown in FIGS. 4a to 4f.

Here, the collision avoidance means 32 is configured to change the speed specification 22₂ associated with the trajectory of the new drive request 34₂ based on the collision information to obtain an amended speed specification 22′₂ to avoid the possible collision. Changing the speed specification can mean, for example, at least temporarily increasing or decreasing the speed specification 22₂. In the case of kinodynamic route planning, where attempts are made to implement the maximum accelerations in each case, the change can mean a decrease in acceleration and/or speed. From this it becomes clear that the speed specification 22 is not necessarily directed to the specification of an actual speed, but can also refer to other parameters, such as acceleration, an energy to be provided to the drive or other control variables.

In any case, embodiments provide that the collision avoidance means 32 adapts the speed specification 22₁ by changing the speed specification 22′₁ as an alternative or in addition to adjusting the speed specification 22₂. In principle, it is possible to avoid a detected collision represented by the collision information by changing one or more speed specifications of vehicles involved in the collision.

The sorting system, such as the collision avoidance means, is configured to transmit the new drive request 34₂ including an instruction that includes the trajectory, such as 14₂, and the amended speed specification 22′₂ to the vehicle 12₂ or its control or vehicle control. For this purpose, for example, wireless transmission techniques can be used, such as 5G, WLAN (Wireless Local Area Network), but also, if needed, wired or other transmission methods. Here, different configurations of the embodiments can be mentioned for differences with regard to the transmission to the vehicle or its control, which are based, for example, on how and at which location the collision avoidance means 32 is implemented and/or which concept or strategy for collision avoidance or prioritization is implemented.

Often, remote transmission of the updated speed profiles to the vehicle can take place, such as when the collision avoidance means 32 is implemented at a remote location. However, even if implemented in the vehicle, transmission within the vehicle, to its control to the vehicle can take place.

Although it is possible that, for example, if the collision avoidance means 32 is implemented on the vehicles themselves and round-robin scheduling is used, which will be explained in more detail in connection with prioritization, and the lower-priority vehicle checks the corresponding collision and further only two vehicles are involved in a collision, this step can also be omitted. However, since such knowledge is rarely available a priori, examination and/or transmission can still be performed. In many or all other variants, it cannot be ensured that only exactly one vehicle needs an amended speed profile, especially in the case of the exhaustive search method as a prioritization strategy, and at the same time this vehicle is still the vehicle to be examined. Therefore, as part of a separate implementation of collision avoidance means 32 and the vehicle control means, it is intended to provide a corresponding transmission to the vehicle/vehicle control means, even if this does not require that a corresponding signal comes from outside the vehicle. Even if, for example, the collision avoidance means 32 is at least partially implemented in software running in the vehicle, this represents a separate software part to the control/movement means of the robot/vehicle, so that the information also has to be “transmitted” here, even if the transmission then takes place within the vehicle, between these two software parts.

From this it becomes clear that the sorting system 10 is configured to calculate the routes and speeds in advance and only in the case of possible collisions to avoid these collisions by ensuring that newly added drive requests do not cause collisions by setting up their speed specifications accordingly. Although this can also lead to configurations in which a vehicle, once on its way, continues to drive at a predefined speed specification until it delivers its transport goods, for example, it is also possible to set the start points 16 and/or the end points 18 in such a way that these are based on a certain time interval, for example, and/or are based on a certain distance and a redetermination, possibly taking into account global optimization criteria, of the speed profiles for one or more or all vehicles that are already driving, even before they deliver their transport goods, which can also be understood to mean that several trajectories are traversed starting from a point in time at which the transport goods are picked up to a point in time at which the transport goods are dispatched.

It should further be noted that although a distinction between a start point and an end point of a trajectory is implemented in the sorting system 10, a corresponding point can be used as both a start point and an end point, for example for different trajectories.

Reference is made below to the planning phase during which the trajectories are determined. For example, the calculating means 24 can be configured to calculate a plurality of trajectory candidates between a start point of a number of possible start points and an end point of a possible number of end points.

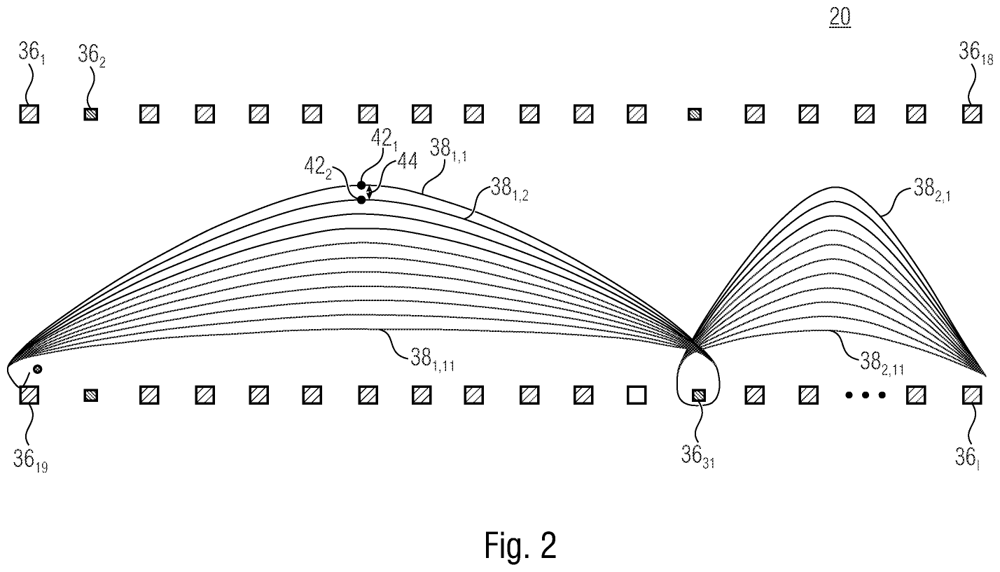

In this regard, reference is made to FIG. 2, illustrating a schematic representation of a part of a sorting system 20 according to an embodiment. Exemplarily, areas 36₁ to 36ₗ are illustrated, some or all of which can be considered both as a start point and as an end point for a trajectory.

The areas 36 can describe a stationary area in the sorting system as a start point and/or end point or, alternatively, can be based on the trajectory. An overall set of areas can also be combinatorial in structure, such that some areas are stationary and other areas are based on the trajectory, such as a start and/or an end of a part of an overall route, a hall entrance, a hall exit, or the like.

Exemplarily, several trajectory candidates 38_{m,n} are illustrated, wherein m describes a trajectory identifier, which in the present embodiment is 1 or 2, and n describes an indexing of the respective trajectory candidate within the trajectory or route connection to be selected. For example, the calculating means 24 can be configured to use the area 36₁₉ as a start point and the area 36₃₁ as an end point for candidates 38_{1,n}, and to use the area 36₃₁ as a start point and the area 36ₗ as an end point for trajectory candidates 38_{2,m}. It should be noted here that the number n of trajectory candidates for different route regions in the present example is the same, but can also be different from each other and can be a number of at least 2, at least 3, at least 5, at least 10, or at least 20 or more.

The coordinating means 28 can be configured to select one of the trajectory candidates as the trajectory for the new drive request. That is, the coordinating means can select one of a plurality of possible routes. For example, different candidates of one route 38m can allow several vehicles to drive in short time intervals, since they can then travel side by side rather than one behind the other.

The calculating means can be configured to calculate the plurality of trajectory candidates 38_{m,n} while taking into account a trajectory curvature. For example, the calculating means 24 can be configured to determine a predefined number of trajectory candidates having a minimum curvature, possibly taking into account additional boundary conditions such as distances between trajectories or the like. Determining a predetermined number of most suitable trajectory candidates can allow to have some margin with respect to several different trajectory candidates, i.e., there is a certain number of options available. Alternatively or additionally, the calculating means 24 can be configured to determine a number of trajectory candidates having trajectory curvatures of at most a predefined curvature threshold. That is, it can be possible to determine all trajectory candidates that satisfy certain curvature threshold boundary conditions, since excessive curvatures can potentially result in low accelerations and/or low speeds. From this point of view, for example, a different number of trajectory candidates can be obtained for the route between the areas 36₃₁ and 36ₗ than for the path between the regions 36₁₉ and 36₃₁. Both criteria can also be combined easily, so that, for example, a fixed number of trajectory candidates satisfying a certain curvature condition is calculated. Other or additional boundary parameters, for example a certain route length, a distance to other objects or the like can also be considered. It should be noted that, with respect to the curvature, in particular a maximum acceleration of the vehicle, that is, the acceleration possibility of the vehicle can provide an important contribution. The maximum possible acceleration in connection with the curvature can be relevant for or determine the physical maximum possible speed along the path.

According to an embodiment, the calculating means is configured to calculate the trajectory based on splines. Optionally, the calculating means 24 can be configured to determine a distance 44 for control points between start point and end point, such as for adjacent vertices 42₁ and 42₂, which indicates a distance of adjacent trajectory candidates. This distance does not necessarily have to be maintained across the entire trajectory and can, for example, be selected differently in the area of the start point and/or the end point or can be omitted.

In principle, there is a high degree of freedom in determining the trajectory candidates. The trajectory candidates allow existing open spaces in the sorting system 10 to be used well to maximally, so that, for example, several lanes can be formed in a wider passage that can be driven in parallel. In addition, several candidates for connecting two areas also provide the ability to switch to other candidates should a blockage or collision be detected.

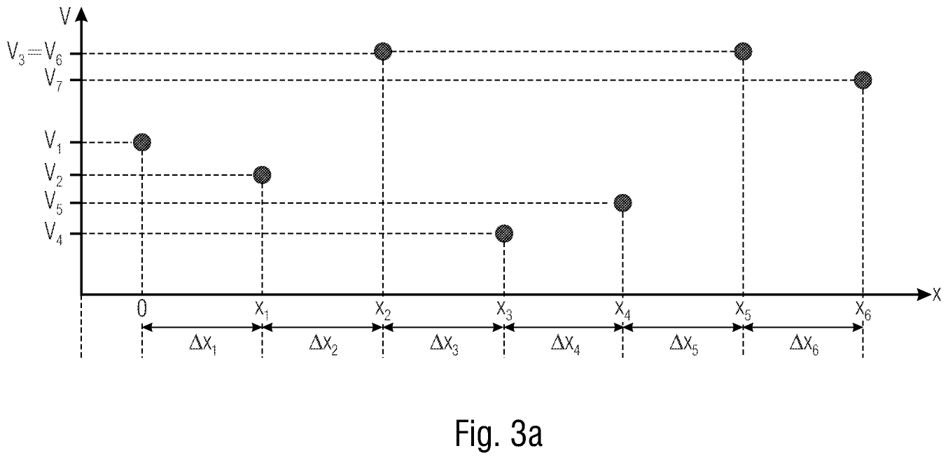

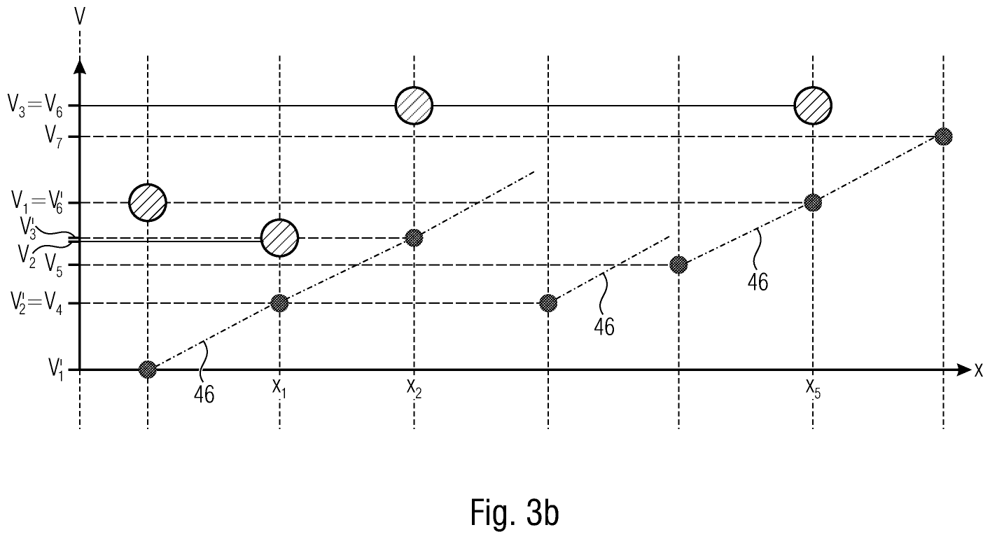

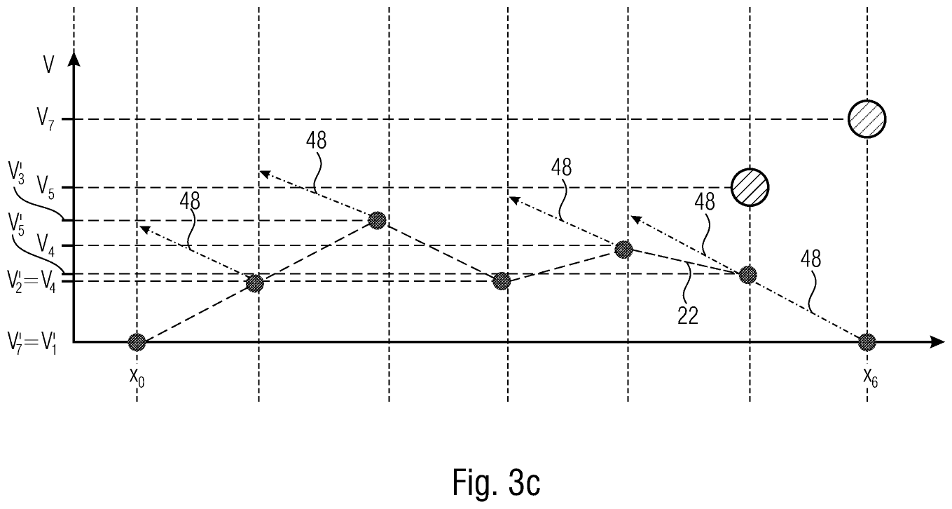

For each of the candidates 38_{m,n} a speed profile, i.e., a speed specification can be calculated, for example in the form of a time-optimal speed profile. This is explained by way of example with reference to FIGS. 3a-c.

For example, FIG. 3a shows a schematic graph in which a total route length at location x₆ of one of the candidates 38_{m,n} of FIG. 2 is divided into several trajectory portions, each having route lengths Δx₁ to Δx₆. Possibly but not necessarily, the trajectory portions Δx₁ to Δx₆ are equidistant, meaning they comprise an equal route length.

For each of the trajectory portions Δx₁ to Δx₆, the number of which can be at least 1, at least 2, at least 3, at least 5, at least 10, or more, the calculating means can calculate a portion speed specification to calculate the speed specification 22 based on a combination of the portion speed specifications. Further, a maximum speed is calculated for each of the portions, as shown in FIG. 3a. Speeds V1 to V7 correspond to the maximum speeds at the respective waypoints. For this purpose, for example, the curvatures on the respective portions are considered or taken into account and the maximum speeds V1 to V7 are calculated from them.

In other words, FIG. 3a shows a determination of the maximum speed at the portions of the trajectory.

FIG. 3b shows a further step for determining the speed specifications. For this purpose, the portions Δx₁ to Δx₆ are iterated through sequentially, for example starting from the route 0 up to the end x₆ and, for example, taking into account the acceleration of the vehicles. This results in deviations, for example, at the beginning (x=0) of the drive, in that the acceleration, exemplarily represented as straight line 46, is applied starting from the actual speed. At the start of the route (x=0), the speed is 0, for example, but this is not mandatory for other embodiments. At other starts and routes, the speed can also be unequal to 0. The slope of the straight line 46 determines which maximum speed V2′ can actually be achieved at location x1, so that a correction takes place here, just as for the speed V3′ at x₂. Further, based on the slope of the constant acceleration 46, a correction takes place at x₅, so that an adapted speed V₆′ is obtained here. It is understood that the acceleration 46 can be represented as a straight line, but that other vehicles can have different acceleration profiles, such as curved trajectories.

In other words, the portions are iterated through from start to finish and the maximum speed is calculated based on the acceleration. FIG. 3b shows a calculation of the real achievable maximum speed.

FIG. 3c further illustrates how the negative acceleration, the deceleration, is taken into account analogously, for example, in order to arrive at the target speed, 0 in the present example, at x₆. In other examples, the final speed can be unequal zero, for example when driving from one area to another and starting a new trajectory in the new area.

Thus, for example, starting from x₆ towards x₀, taking into account a possible maximum negative acceleration 48, the braking capability can be taken into account by plotting corresponding exemplary but vehicle-dependent straight lines, wherein iteration also takes place. In this way, the speed specification 22 can be determined combinatorically in the individual portions and overall for the trajectory.

In other words, at the end, the portions are traversed backwards so that the maximum achievable speed also takes into account the braking maneuvers, as shown in FIG. 3c. Thereby, for each trajectory portion, the curvature of the trajectory portion, the maximum acceleration of the vehicle both as positive and negative acceleration, are used by the calculating means to calculate a maximum speed. Based on maximum speeds, a speed specification at the beginning of the trajectory portion, FIG. 3b, and a speed specification at an end of the trajectory portion, FIG. 3c, the portion speed specification can be calculated by adapting the maximum achievable or desired speed to the original specification of FIG. 3a. FIG. 3c shows a calculation of the maximum achievable speed taking into account the braking maneuvers.

According to an embodiment, the calculating means can be configured to calculate the speed specification kinodynamically as time-optimized speed specification. This means that for each trajectory the speed specification is determined in such a way that the shortest possible time is needed to traverse the trajectory.

According to an embodiment, the coordinating means is configured to select the trajectory for the new drive request from a plurality of trajectory candidates, such as one of the n candidates for a particular route. The plurality of trajectory candidates can take into account trajectories already assigned to vehicles in existing drive requests. This means that vehicles about to start or already driving can already occupy trajectory candidates, which is taken into account by the coordinating means.

According to an embodiment, the collision avoidance means 32 is configured not to adapt the speed specification for the already assigned trajectories of existing drive requests, so that, for example, a reduction of the speed specification obtained as a result of FIG. 3c is performed only for the new speed specifications to be added or to be updated in handover portions.

According to an embodiment, the coordinating means 28 is configured to consider vehicles on already assigned trajectories for the selection of the trajectory as a potential obstacle. These can be taken into account by selecting corresponding trajectories that pass the potentially moving obstacle and/or by adapting the speed specification.

According to an embodiment, the collision avoidance means is configured to obtain a plurality of corresponding trajectories as a respective time-optimal speed specification for traversing the trajectory for a plurality of new drive requests, i.e., a plurality of vehicles are to be provided with drive requests. For the plurality of new trajectories, the collision avoidance means 32 can determine possible collisions among the vehicles, within the new drive requests, and avoid the possible collisions within the new drive requests by adapting at least one of the speed specifications. This allows for mutual consideration of the drive requests to each other, while still allowing existing drive requests to remain untouched. At this point, the object is not just to control a single vehicle in a time-optimum manner and merely avoid collisions with the rest of the vehicles. Rather, the object of embodiments described herein is to optimize the time for all vehicles while taking into account the boundary condition of no collisions. Even if new speed profiles/requests are adapted with respect to each other relative to existing requests, the existing requests can still be adapted in a next iteration, such as a next route portion or a next time portion, when an updated calculation is performed. With reference to FIGS. 3b and 3c, this is possible, for example, for trajectories where the initial speed and/or the final speed is unequal 0.

According to an embodiment, a set of time-optimized collision-free drive requests is thus obtained globally for the plurality of vehicles by means of amended speed specifications.

In this case, the collision avoidance means 32 can be configured to determine for which of the vehicles involved in the possible collision the speed specification is to be adapted. In this case, the speed specification can be adapted, for example reduced in portions, for one of the two vehicles involved or for both of the vehicles involved in a new drive request, whereby this is also possible without restrictions for a number of more than two vehicles that would be involved in a potential collision.

The collision avoidance means 32 can be configured to implement at least one of a predefined priority, an exhaustive search method, or a combination thereof. For example, a priority can take into account a priority of the goods and/or the priority can be assigned to the vehicle. This enables a fixed ranking or order so that it is clear, based on the order, for which vehicle's drive request to make an adaptation. This information can be known to the vehicles and is known at least to the central coordination point, the collision avoidance means. An example of such a predefined prioritization is the so-called round-robin scheduling.

According to an embodiment, the collision avoidance means is configured to determine possible collisions for a plurality of new drive requests, and to match the speed specifications of the speed profiles assigned to the drive requests by the coordinating means, optionally leaving already transmitted speed profiles or adapted speed profiles unamended.

According to an embodiment, the collision avoidance means 32 is configured to treat already amended speed specifications as unchangeable until the drive request of the assigned trajectory is completed. In some embodiments, this can also refer only to the partial route of the total distance to be traveled.

According to an embodiment, the coordinating means 28 is configured to determine the new drive request as a common drive request to a vehicle group or a vehicle formation for a common drive along the trajectory, such as for particularly heavy goods and/or particularly bulky goods. The trajectory can be selected such that vehicles of the formation are staggered relative to the trajectory based on the formation, for example, one vehicle slightly to the left thereof and one vehicle slightly to the right thereof, or such that vehicles move along or parallel to the trajectory at an invariable distance from each other.

Embodiments described herein are particularly suitable for holonomic vehicles whose driving means comprise, for example, so-called “omni-wheels”. In particular, a combination with a calculation of the speed specification as a kinodynamic calculation for obtaining time-optimized speed specifications provides considerable advantages.

Referring again to FIG. 1, embodiments also provide for the implementation of a sorting system control means including, for example, coordinating means such as the coordinating means 28 that is configured to transmit drive requests to a plurality of vehicles, wherein each drive request includes a drive from a start point to an end point along a respective trajectory. Here, a speed specification for a vehicle along the trajectory is associated to each trajectory. Further, the sorting system means 26 includes a collision avoidance means such as the collision avoidance means 36 configured to examine, for a new drive request, an associated trajectory for possible collisions with a drive request to obtain collision information indicating a possible collision and to change the speed specification associated to the trajectory based on the collision information and to obtain an amended speed specification in order to prevent the possible collision. The sorting system control means includes an interface for outputting the new drive request including an instruction that includes the trajectory and the amended speed specification. This means the sorting control means 26 can also be implemented or delivered independent of further components of the sorting system 10 and can only be joined later to an overall system.

According to an embodiment, the sorting system control means 26 includes calculating means, such as calculating means 24 that is configured to determine a third number of trajectories between a first number of start points and a second number of end points, such as a plurality of trajectory candidates each or merely one trajectory, wherein the coordinating means is configured to assign drive requests to the trajectories.

The considerations concerning embodiments described herein will be discussed again in other words with reference to a specific embodiment. As background for these explanations, the following circumstances are assumed for vehicles described herein, which are also referred to as LoadRunner and the respective field of usage:
The vehicles, i.e. the LoadRunners, can realize high speed as well as high accelerations. For example, the vehicles can have maximum speeds of 10 m per second and more and accelerations of 4 to 5 m/s² or more;
This has the disadvantage that these vehicles cannot or only hardly react to dynamically occurring obstacles, such as a person walking through the area or across the lane, since a breaking distance of approximately 10 to 12 m or more can result at maximum speed;
This results in the fact that the vehicles cannot easily be operated in a reactive manner and with “swarm heuristics” but with trajectories that are planned in advance;
By the usage of omni wheels, a Load Runner is a so-called “holonomic robot”. This means that the number of controllable degrees of freedom is equal to the number of degrees of freedom existing overall in the system. A holonomic robot can mean means that are able to traverse any trajectory in the so-called configuration space, i.e. effectively the space formed of the three degrees of freedom with the positions X, Y and the rotation as long as the boundary conditions of acceleration are maintained. For the case of flying means, the z component can also be considered. Vehicles such as an automobile, which is not able to drive sideways into a parking space, are in contrary to that. For this, quite complicated trajectories have to be selected in order to move the vehicle 2 m to the side, for example as the automobile only has two controllable degrees of freedom. Here, it is assumed that systems of vehicles driving on the ground have three degrees of freedom all in all, two for the positions X and Y, and one for the rotation;
For using vehicles in a sorting system, it is important, among others, that the trajectories between the feeding points, i.e. the location where a new packet is received and the end locations are optimum. Normally, no optimum trajectories from and to any points in the room are needed, as merely the sorting circuit is of significance, which can predetermine the points. Additionally, it is possible to provide a large free driving area in the layout of the sorting system. This point can be of significant importance as it cancels the large disadvantage that the trajectories have to be pre-calculated statically for a certain time according to embodiments. One of the core ideas of the solution method is that the two conditions are used and the multi-agent path finding problem, which is basically very difficult to solve, in particular for kinodynamic route planning is eased by placing route planning according to kinodynamic boundary conditions at the beginning, such as by the calculating means and the coordinating means, and the actual collision avoidance of the vehicles is realized via the speed profiles along these paths, such as by the collision avoidance means.

An inventive method can basically be divided into the following three steps:
1. For a time period T, all paths that can be used in the next steps are determined. For a sorting scenario, this means specifically the paths from all sources used in a time period T to all sinks used in the time period T including return of the vehicles to, for example, a charging station or a buffer zone. Normally, several candidates can be generated for a connection, see the explanations in FIG. 2 in order to provide more avoidance options. The time period T can be comparatively large and can be, for example, 1 minute, at least 5 minutes or at least 10 minutes.
2. The allocation of the transport requests to the vehicles. Here, it is determined which vehicle has to drive “from where to where”. Each vehicle checks all present candidates for its drive request. The selection of a trajectory candidate as a candidate can hence be implemented in a central or decentral manner, which means that the sorting system control means 26 or the coordinating means 28 can also be implemented locally in a vehicle. In such a case, the same can return the selection made to the sorting system control means or can also perform collision avoidance.
3. Collision avoidance by adapting the speed profiles with possible collision candidates.

This step takes place before the vehicle has started or before the current trajectory starts.

In a first step, the trajectory candidate determination, several path candidates 38_{m,n}, which have a curvature that is as low as possible, are calculated for each source/sink combination, so that accelerations that are as high as possible and speeds connected therewith can be obtained. For example, in order to stay in track on the curved path, the centrifugal force has to be counteracted. This means the vehicle uses part of its maximum possible acceleration only to stay in track and not to accelerate along the path. For maximum acceleration along the path, therefore all paths having a curvature as low as possible are desirable. When generating the paths, for example, splines are used, wherein the control points at start and end are fixed. For the control points between start and end, depending on the length, an interval is defined, which determines how far apart the control points of the individual candidates are to be from each other, for example by the distance 44. In that way, it can be ensured that needed points at delivery and dispatch locations are exactly traversed and the free space on the free area is used uniformly or according to other regulations, as illustrated, for example in FIG. 2.

For each candidate, a time optimum speed profile can be calculated. Here, the portions of the trajectory are divided equidistantly and for each portion the curvature and the resulting maximum speed is calculated, see FIG. 3a. Subsequently, the portions are iterated through from start to end and the maximum speed is calculated based on the acceleration, see FIG. 3b. Then, the portions are traversed backwards, such that the maximum obtainable speed also considers the breaking maneuvers, see FIG. 3c.

Further, the transport requests are assigned to the vehicles. This determines which vehicle has to drive from where to where. Each vehicle examines all existing candidates or candidates determined for selection for its drive request.

In a second step, the transport requests are assigned to the present vehicles, wherein it is determined which drive candidates are available for the vehicle. It is to be noted that a part of all transport requests and associated trajectories is fixed, i.e. unamendable, while another part is in planning. This means, for example, that the trajectories that are currently traversed by a vehicle or will start shortly have a fixed speed profile which can no longer be amended by the collision avoidance (see point 3) of the other participants. This results, on the one hand, from the long breaking distances but also from the communication and processing time for calculating the optimum profiles. In the current step, these vehicles are considered as static obstacles and are considered when selecting a path candidate. For the current request, a path having as little obstacles as possible is selected.

In a third step, which is performed after the second step, the speed profiles are determined for the paths, wherein first each vehicle starts with a time-optimum profile. Since the paths in step 1 have been planned as time-optimum trajectories, it is possible to traverse the same with a maximum possible speed without deviating from the path. In this embodiment, collision avoidance therefore makes the vehicles merely slower and not faster. This ensures that the paths can be traversed exactly with reduced speed, as the centrifugal forces influencing the acceleration are also lower. First, all collisions are determined that can occur in the current speed profiles. As all paths are known in advance due to step 1, it is known for each vehicle with which vehicles it could theoretically collide. This provides for enormous savings of computing time as the scenarios to be considered can be limited thereto. The collisions are avoided in that a vehicle adapts its speed profile in an intelligent manner.

For adapting the speed profile, embodiments provide different strategies:
a) The usage of a fixed prioritization, for example as round-robin scheduling. This is a simple and fast variation. Here, it is determined in advance for the case of a collision which vehicle will adapt its speed. This can be determined either by a fixed order (such as vehicle A has priority over vehicle B), by an arbitrary order where the collisions are examined (collision of vehicle B with vehicle A has been examined before the collision of vehicle A with vehicle B has been examined, which is why vehicle B receives priority), by the timestamp of the transport request such that for example, the vehicle A starting earlier has priority over the vehicle B starting later by the priority of the request (vehicle A has to arrive prior to vehicle B, therefore vehicle A has priority) or by an arbitrary selection method. Here, it is merely relevant that both vehicles comprise all information to know, to detect or determine the order in agreement. This concept has the advantage that only one of the two vehicles has to adapt its speed profile and has to examine it again for collisions with other vehicles which makes it possible to find a quick solution. It is possibly disadvantageous that the found solution is not optimum for the entire sorting system, such as in that the vehicle A has priority over vehicle B, but both would be faster if vehicle A would wait for vehicle B.
b) Exhaustive search: in this variation, several options of conflict avoidance or collision avoidance are simulated. If, for example, vehicle A collides with vehicle B, both avoidance options (vehicle A breaks for vehicle B or vehicle B breaks for vehicle A) are simulated. This possibly results in new collisions with other candidates that are currently in planning. All these options are sorted in a tree structure. The leaves of the trees represent collision-free trajectories for all involved vehicles. Thereby, a truly optimum solution is determined for all participants for collision avoidance. However, this method is performed at the expense of the execution time as the tree to be searched might be very large and complex.
c) A combination thereof, an attempt is made to combine the best of both methods, A and B. In possible collisions, the possibility tree is built up again, but only to a certain depth, i.e. the search has a time limit. If an optimum solution cannot be found fast enough, the system falls back to the predefined order according to option a).

For example, the planning phase is terminated as soon as an optimum or suboptimum solution has been found for the candidates. From this time onwards, the trajectory is fixed, i.e. subsequent plannings of the vehicles can, for example, no longer influence the same or merely when reaching predetermined priorities or other predefined exceptional situations.

The steps 2 and 3, the allocation of the transport requests and adapting the speed profile are successively performed for each vehicle again. As soon as the situation in the store needs a new route network, the process starts again with the determination of the trajectories in step 1.

A specific field of usage of holonomic vehicles is that several individual vehicles can form a formation which behaves like a single greater vehicle. Such formation drives can also be realized by the above-described solution. For this, in a first step, a trajectory is generated for the entire formation from which the trajectories of the individual vehicles are formed via the known offset of each vehicle from the formation center. Steps 2 and 3, i.e. drive request allocation and speed adaptation can be performed analogously as in all other participants with the limitation or additional boundary condition that the speed profiles of all formation vehicles are adapted together and the trajectories start simultaneously.

By the embodiments described herein, the specific technical advantages of the holonomic vehicles can be used such that high accelerations and speeds can be driven by the kinodynamic route planning. Contrary to known methods, reactive avoidance and large safety distances can be omitted and, hence, a large number of vehicles can perform transport requests simultaneously.

Embodiments can, in particular, be used when realizing sorting plants or sorting systems with autonomously driving transport vehicles.

Embodiments also provide a method for operating a sorting system and for operating sorting system control means.

A method for operating a sorting system to move a plurality of vehicles in the sorting system along trajectories includes calculating a number of trajectories between a first number of start points and a second number of end points, such that a speed specification is allocated to each trajectory for a vehicle along the trajectory. Further, drive requests are transmitted to the plurality of vehicles, such that each drive request includes a drive from one of the start points to one of the end points along one of the trajectories. Further, examining a trajectory for a new drive request for possible collisions with a further vehicle of the sorting system takes place to obtain collision information indicating a possible collision. The method includes amending the speed specification allocated to the trajectory based on the collision information to obtain an amended speed specification and to prevent the possible collision. Further, the new drive request including an instruction comprising the trajectory and the amended speed specification is transmitted to a vehicle.

A method for operating a sorting system control means includes transmitting drive requests to a plurality of vehicles, such that each drive request includes a drive from a start point to an end point along a respective trajectory, such that a speed specification for a vehicle along the trajectory is allocated to each trajectory. The method includes examining, for a new drive request, of an allocated trajectory for possible collisions with a drive request to obtain collision information indicating a possible collision. Further, the speed specification allocated to the trajectory is amended based on the collision information to obtain an amended speed specification and to prevent the possible collision. The new drive request including an instruction that includes the trajectory and the amended speed specification is output.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Generally, embodiments of the present invention can be implemented as a computer program product with a program code, the program code being operative for performing one of the methods when the computer program product runs on a computer. The program code may, for example, be stored on a machine readable carrier.

Other embodiments comprise the computer program for performing one of the methods described herein, wherein the computer program is stored on a machine readable carrier.

In other words, an embodiment of the inventive method is, therefore, a computer program comprising a program code for performing one of the methods described herein, when the computer program runs on a computer. A further embodiment of the inventive method is, therefore, a data carrier (or a digital storage medium or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

I/we claim:

1. Sorting system controller, comprising:
a coordinator configured to transmit drive requests to a plurality of vehicles, wherein each drive request comprises a drive from a start point to an end point along a respective trajectory; wherein a speed specification for a vehicle along the trajectory is allocated to each trajectory;
a collision avoidance unit configured to examine, for a new drive request, an allocated trajectory for possible collisions with a drive request to acquire collision information indicating a possible collision; and to amend the speed specification allocated to the trajectory based on collision information to acquire an amended speed specification; and to prevent the possible collision;
an interface for outputting the new drive request comprising an instruction that comprises the trajectory and the amended speed specification.

2. Sorting system controller according to claim 1, wherein the speed specification associated with the trajectory is a speed specification based on a predetermination and comprises a speed profile for a speed across a path of the trajectory; and the collision avoidance unit is configured to adapt the speed specification subsequently and prior to transmission of the drive request by the amended speed specification to avoid the possible collision.

3. Sorting system controller according to claim 1, wherein the coordinator is configured to select, for the new drive request, the trajectory from a plurality of trajectory candidates; wherein the plurality of trajectory candidates considers trajectories already allocated to vehicles in existing drive requests.

4. Sorting system controller according to claim 1, wherein the collision avoidance unit is configured to not adapt the speed specification for already allocated trajectories of existing drive requests.

5. Sorting system controller according to claim 3, wherein the coordinator is configured to consider vehicles on already allocated trajectories for the selection of the trajectory as potential obstacles.

6. Sorting system controller according to claim 1, wherein the collision avoidance unit is configured to acquire, for a plurality of new drive requests, a plurality of corresponding trajectories as respective time-optimum speed specification for traversing the trajectory and to determine, for the plurality of the new trajectories, possible collisions among the vehicles and to prevent the possible collisions within the new drive requests by adapting at least one of the speed specifications.

7. Sorting system controller according to claim 1, wherein the collision avoidance unit is configured to determine possible collisions for a plurality of new drive requests and to match the speed specifications of the speed profiles allocated to the drive requests by the coordinator; wherein already transmitted speed profiles remain unamended.

8. Sorting system controller according to claim 1, wherein the collision avoidance unit is configured to treat already amended speed specifications as unamendable until the drive request on the allocated trajectory is terminated.

9. Sorting system controller according to claim 1, comprising:
a calculator configured to determine a third number of trajectories between a first number of start points and a second number of end points, wherein the coordinator is configured to allocate drive requests to the trajectories.

10. Sorting system controller according to claim 9, wherein the calculator is configured to calculate a plurality of trajectory candidates between a start point of the first number of start points and an end point of the second number of end points;
wherein the coordinator is configured to select one of the trajectory candidates as trajectory for the new drive request.

11. Sorting system controller according to claim 9, wherein the calculator is configured to calculate the trajectory based on splines.

12. Sorting system controller according to claim 9, wherein the calculator is configured to calculate the speed specification in a kinodynamic manner as time-optimized speed specification.

13. Sorting system controller according to claim 1, wherein the trajectory describes a continuous path or a continuous route between a start point and an end point.

14. Sorting system controller according to claim 1, wherein the trajectory comprises a plurality of trajectory portions, wherein the calculator is configured to calculate a portion speed specification for each trajectory portion; and to calculate the speed specification based on a combination of the portion speed specifications.

15. Sorting system controller according to claim 14, wherein the calculator is configured to calculate a maximum speed for each trajectory portion based on a curvature of the trajectory portion and a maximum acceleration of a vehicle; and to calculate the portion speed specification based on the maximum speed, a speed specification at the start of the trajectory portion and a speed specification at an end of the trajectory portion.

16. Sorting system, comprising:
a plurality of vehicles configured to move along trajectories in the sorting system;
sorting system controller according to any of the preceding claims comprising calculator configured to calculate a third number of trajectories between a first number of start points and a second number of end points, wherein a speed specification for a vehicle along the trajectory is allocated to each trajectory;
wherein the sorting system is configured to transmit, by means of the interface, the new drive request comprising the instruction that comprises the trajectory and the amended speed specification to a control of a vehicle.

17. Sorting system according to claim 16, wherein a start point and/or an end point is a stationary area in the sorting system; or is based on the trajectory.

18. Sorting system according to claim 16, wherein the plurality of vehicles comprises holonomic vehicles.

19. Sorting system according to claim 16, wherein the coordinator is configured to transmit the new drive request as a common drive request to a vehicle group or a vehicle formation for a common drive along the trajectory.

20. Method for operating a sorting system controller comprising:
transmitting drive requests to a plurality of vehicles, such that each drive request comprises a drive from a start point to an end point along a respective trajectory; such that a speed specification for a vehicle along the trajectory is allocated to each trajectory;
examining, for a new drive request, an allocated trajectory for possible collisions with a drive request to acquire collision information indicating a possible collision; and amending the speed specification allocated to the trajectory based on the collision information to acquire an amended speed specification; and to prevent the possible collision;
outputting the new drive request comprising an instruction that comprises the trajectory and the amended speed specification.
